(19) United States
(12) Patent Application Publication
(10) Pub. No.: US 2018/0355831 A1
(43) Pub. Date: Dec. 13, 2018

(54) INJECTOR FOR A COMBUSTION ENGINE

(71) Applicant: CONTINENTAL AUTOMOTIVE GMBH, Hannover (DE)

(72) Inventors: Marco Maragliulo, Empoli / FI (IT); Francesco Sabatini, Pistoia (PI) (IT)

(73) Assignee: CONTINENTAL AUTOMOTIVE GMBH, Hannover (DE)

(21) Appl. No.: 15/910,569

(22) Filed: Mar. 2, 2018

Related U.S. Application Data
(63) Continuation of application No. PCT/EP2016/068999, filed on Aug. 10, 2016.

(30) Foreign Application Priority Data
Sep. 3, 2015 (EP) 15183644.2

(51) Int. Cl. F02M 61/12; F02M 51/06

(52) U.S. Cl. CPC F02M 61/12; F02M 2200/9053; F02M 51/0685

(57) ABSTRACT

An injector for a combustion engine includes a pole piece, an armature, a valve needle and a guiding element with a guiding portion. Respective penetrating openings of the pole piece and the guiding element provide a fluid channel for the fluid along a longitudinal axis of the injector. The valve needle is arranged axially moveable along the longitudinal axis to prevent or enable a fluid flow. The guiding element is at least partially arranged and axially moveable inside the penetrating opening of the pole piece and realizes a guidance of the valve needle along the longitudinal axis. The guiding portion is configured to be in contact with the pole piece and has a cylindrical shape.

### CROSS REFERENCE TO RELATED APPLICATIONS

This application is a continuation of International application No. PCT/EP2016/068999, filed Aug. 10, 2016, which claims priority to European application No. 15183644.2, filed on Sep. 3, 2015, each of which is hereby incorporated by reference.

### FIELD OF THE INVENTION

The invention relates to an injector for a combustion engine.

### BACKGROUND

Injectors are in widespread use in particular for combustion engines where they may be arranged in order to dose the fluid into an intake manifold of the combustion engine or directly into a combustion chamber of a cylinder of the combustion engine.

In general, an injector has tough performance requirements to enable injection of accurate quantities of fluids and to fulfill pollution restrictions during operation of the injector and the corresponding combustion engine. One general requirement is to prevent wearing effects during operation of the injector to enhance its lifetime and to realize a secure and reliable functioning of the injector.

For example, this concerns guidance of a valve needle of an injector and corresponding contact surfaces. Normally, the valve needle is guided at two ends, an upper and a lower end, to enable a linear movement preferably. In case of a solenoid injector, an upper guiding portion might be realized in a pole piece and a lower guiding portion might be realized in a nozzle. Each guiding portion contains moveable guiding surfaces and corresponding immovable guiding surfaces. Moveable guiding surfaces may be manufactured directly on the valve needle, an upper stopper at the upper end and a ball at the lower end of the valve needle, for instances.

In document DE 10 2004 056 424 A1 an injector and a method for a structuring of a pole piece is described wherein the injector comprises a support element and a valve needle which are arranged inside an opening of a pole piece. In this context, the pole piece comprises specially structured lateral channelings for fluid transportation.

### SUMMARY

One object of the invention is to create an injector for a combustion engine which enables a reliable and secure functioning of the injector with an improved guidance of a valve needle.

An injector for a combustion engine is disclosed. The injector has a longitudinal axis. It comprises a pole piece with a penetrating opening, an armature with a penetrating opening, a valve needle and a guiding element. The guiding element has a guiding portion and a penetrating opening.

At least the respective penetrating opening of the pole piece and the guiding element are configured to form a portion of a fluid channel for a fluid along the. In particular, the injector is a fluid injector with a fluid inlet and a fluid outlet. The fluid channel hydraulically connects the fluid inlet to the fluid outlet.

Further, the valve needle is arranged at least partially inside the penetrating opening of the armature and is configured to be axially moveable along the longitudinal axis to prevent a fluid flow in a closed position of the valve needle and to enable a fluid flow in an opened position of the valve needle. In this way, the valve needle is in particular operable to control fluid flow through the fluid outlet.

The guiding element is arranged with the guiding portion at least partially inside the penetrating opening of the pole piece. The guiding portion is in contact with the pole piece; it may expediently be in sliding mechanical contact with the penetrating opening of the pole piece. In one embodiment, the guiding portion has a cylindrical shape.

The guiding element is axially moveable along the longitudinal axis. In particular, it is longitudinally displaceable relative to the pole piece and relative to the valve needle. It is coupled to the valve needle to realize a guidance of the valve needle along the longitudinal axis during operation of the injector. In particular, the guiding element is operable to prevent tilting of the valve needle with respect to the longitudinal axis by means of a form-fit and/or force-fit connection with the valve needle.

Such a configuration of an injector for a combustion engine realizes in a simple manner a reliable and secure functioning of the valve needle and a corresponding injector with an improved guidance of the valve needle due to the guiding element. Such a guiding element, in particular arranged in an upper portion of the injector inside the penetrating opening of the pole piece, enables a particularly good linear guidance of the valve needle, in particular as compared to injectors which do not comprise such a guiding element.

Regarding its geometry and material, the guiding element may be realized as a simple and low cost component of the injector and enables an easy manufacturing process. Hence, a complexity of a guiding portion of the injector is reduced due to the very simple design. The guiding element may be shaped as a sleeve or a cap and is in particular manufacturable in a simple and cost-efficient manner by a stamping process out of a given raw material.

A large contact area between the guiding element and the pole piece in case of a cylindrical guiding portion may contribute to a particularly exact linear guidance of the valve needle. This may counteract wearing and hence may increase the lifetime of the injector.

During operation of the injector and motion of the valve needle, an outer surface of the guiding portion of the guiding element slidingly contacts an inner surface of a wall of the pole piece inside the penetrating opening and hence enables particularly good linear guidance. With advantage, the guiding element is positioned in the fluid channel so that friction between the pole piece and the guiding portion may be particularly small. There may be no need for special coatings of cooperating guiding surfaces to counteract wearing. This further simplifies a manufacturing process and lowers costs of the injector because some coating parameters as thickness and depth have a high sensibility and are difficult to control.

A particularly high precision is achievable when producing the guiding element, for example because the cylindrical shape of the guiding portion allows centerless grinding.

The increased precision further allows for lower clearances between cooperating components and hence reducing possible non-coaxiality. With respect to the longitudinal axis of the injector, this concerns a coaxiality of the armature inside a valve body of the injector, for example. If the concentricity of the armature inside the valve body is improved side magnetic forces are reduced which further lowers wearing of the injector.

Due to the enhanced precision concerning linear guidance of the valve needle the described injector and especially the guiding element further enables abdication of a chrome plating inside the penetrating opening of the pole piece and a PVD-coating at an upper end of the valve needle, for example. This further simplifies a manufacturing process of the injector because some coating parameters as thickness and depth have a high sensibility and are hardly under control and contribute to a cost-efficient fabrication.

According to one embodiment, the guiding element includes a contact surface that abuts an end of the valve needle.

Such a simple contact between the guiding element and the valve needle enables one elementary possibility to realize the coupling of these two components. For example, the guiding element is pressed to the valve needle and mechanically contacts an upper end of the valve needle by its contact surface. Hence, there is no need to couple the guiding element to the valve needle by welding or press-fit connection. This further increases the choice of material of the guiding element.

The coupling between the guiding element and the valve needle is in particular configured such that the guiding element and the coupled valve needle are free from axial tipping with respect to the longitudinal axis. In one embodiment, the guiding element includes a shape that partially surrounds the upper end of the valve needle and hence enables a secure and reliable coupling. In other words, the contact surface of the guiding element laterally surrounds the upper end of the valve needle at least in places. Preferably, the contact surface is concavely shaped.

According to a further embodiment, the contact surface of the guiding element includes a spherical shape. A spherically shaped contact surface of the guiding element enables a beneficial contact between the guiding element and the valve needle. A spherical or rotationally symmetric contact surface enables in a simple manner a rotation freedom of the valve needle during operation which is beneficial to compensate tolerances of manufactured components of the injector. Using such a configuration of the injector, there is no need for complex geometries like barrel-shaped guiding elements to avoid contact with edges of the cooperating components.

According to a further embodiment, the guiding element contains or is of a non-iron-based material. According to a further embodiment, the guiding element contains or is of a diamagnetic and/or paramagnetic material.

Because the guiding element is not necessarily welded to the valve needle, it may be made from non-iron based material such as plastic, for example. This enables a very simple manufacturing process of the guiding element and further counteracts any undesirable magnetism effects. Amongst others, the choice of material is enabled by the large contact area due to the cylindrical shape of the guiding element or at least the guiding portion of the guiding element. There is no necessity to use hard material and shapes with low contact area to avoid wearing.

Hard materials are mostly iron based and may cause undesirable magnetism effects, for example due to imperfect coaxiality of arranged components. Due to the possible use of non-iron based materials, the described injector enables to prevent undesirable magnetism effects and hence further counteracts wearing and contributes to a reliable functioning and an improved lifetime of the injector.

According to a further embodiment, the valve needle is partially arranged inside the penetrating opening of the guiding element.

Such a configuration of the injector and the coupling between the guiding element and the valve needle realize a secure and reliable linear guidance of the valve needle and functioning of the injector. For example, the valve needle includes a protrusion at its upper end which abuts the contact surface of the guiding element. The protrusion may be arranged in a correspondingly formed recess or through a correspondingly formed opening in the contact surface of the guiding element. This enables a further fixation of the coupling between the guiding element and the valve needle additionally to the mechanically pressed contact, for instance. Hence, it contributes to a secure and reliable coupling and counteracts an axial tipping of the valve needle and the coupled guiding element during operation.

According to a further embodiment, the injector further includes an elastic element being configured to exert a force on the guiding element to press the guiding element to the valve needle. The elastic element is in particular a return spring which is operable to bias the valve needle towards the closed position by transferring a force to the valve needle in axial direction via the guiding element.

The elastic element generates a force that acts on the guiding element and presses it to the upper end of the valve needle to retain the mechanical contact between the guiding element and the valve needle. For example, the elastic element is arranged above the guiding element by means of an opposite side of the guiding element as the upper end of the valve needle. Such an arrangement realizes in a simple way a predetermined position of the guiding element with respect to the valve needle.

According to a further embodiment, the elastic element is arranged inside the penetrating opening of the pole piece. This configuration of the injector enables a simple possibility for a symmetrical arrangement of the cooperating components aligned along the longitudinal axis of the injector, for example.

According to a further embodiment, the elastic element includes a spring element.

An elastic element with a spring element acting together with the described guiding element realizes in a simple manner a low-cost injector which enables secure and reliable linear guidance of the valve needle. The spring element might be arranged above the guiding element with a fixed load and hence generates a given force that presses the guiding element to the upper end of the valve needle and further presses the valve needle to its closed or opened position whether the corresponding injector is an inward or outward opening injector.

According to a further embodiment, the guiding element includes a lower portion being arranged between the guiding portion and the valve needle and the lower portion includes at least one flow passage being configured to enable a fluid flow through the injector during operation. For example, the flow passage(s) extend(s) in a radial direction through a sidewall of the guiding element to the penetrating opening. Preferably, the flow passage(s) is positioned adjacent to the valve needle. The penetrating opening of the guiding element has, in particular, a fluid inlet aperture at a first axial end of the guiding element remote from the valve needle. In this way, fluid may enter the penetrating opening of the guiding element through the fluid inlet aperture and leave the penetrating opening through the flow passage(s) on its way through the fluid channel, in particular to the fluid outlet of the injector. For example, flow passages are represented by oblique cuts through an outer circumferential edge region of the sleeve-shaped guiding element at a second axial end thereof which adjoins the valve needle.

This configuration of the injector enables one possibility to realize a fluid channel through the injector. The one or more flow passages then form one part of the penetrating opening of the guiding element and enable fluid to flow out of the penetrating opening of the guiding element to an outside section of the guiding element. Good lubrication of the guiding portion and/or the contact surface is achievable in this way.

Regarding the described components, a streaming fluid first passes the penetrating opening of the pole piece and enters the penetrating opening of the guiding element. The fluid further passes the penetrating opening of the guiding element and exits it through the one or more flow passages to enter outside section of the guiding element and a region of the armature. Hence, during operation of the injector, the guiding element is be passed through by fluid, in particular fuel. The fuel is in particular liquid fuel such as gasoline or diesel.

### BRIEF DESCRIPTION OF THE DRAWINGS

Embodiments of the invention are explained with the aid of schematic drawings and reference numbers. Identical reference numbers designate elements or components with identical functions. The figures show:

FIG. 1 shows an embodiment of an injector in a longitudinal section view;

FIG. 2 is an enlarged view of a part of the injector according to FIG. 1; and

FIG. 3 is a perspective view of the guiding element of the injector according to FIG. 1.

### DETAILED DESCRIPTION

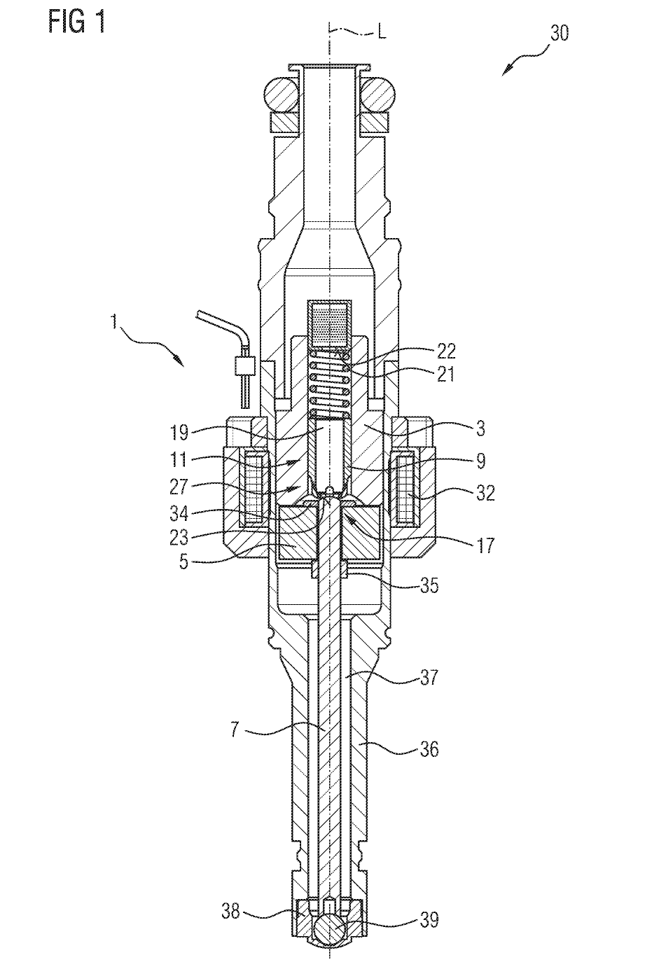

FIG. 1 shows a longitudinal section view of an exemplary embodiment of an injector 30. The injector is in particular a fuel injector which is configured to inject fuel such as gasoline directly into the combustion chamber of an internal combustion engine.

The injector 30 has a longitudinal axis L. Injector 30 includes a pole piece 3, an armature 5 and a valve needle 7. The injector further comprises an elastic element 21, a coil 32, an upper stopper 34, a lower stopper 35, a valve body 36 with a penetrating opening 37, a nozzle 38 and a nozzle tip 39.

The valve needle 7 is partially arranged inside a penetrating opening 15 of the armature 5. The valve needle 7 is axially moveable with respect to the valve body 36 along the longitudinal axis L and prevents a fluid flow through the injector 30 in a closed position or otherwise enables fluid flow in an opened position. An opening or closing process happens due to a coaction of the nozzle 38 and the nozzle tip 39 which contacts the nozzle 38 in the closed position of the valve needle 7, for example.

The valve needle 7 and the injector 30 open due to a magnetic force generated by the coil 32 and close due to an elastic force given by the elastic element 21 wherein a hydraulic force generated by a streaming fluid also influences the opening and closing process during an operation of the injector 30.

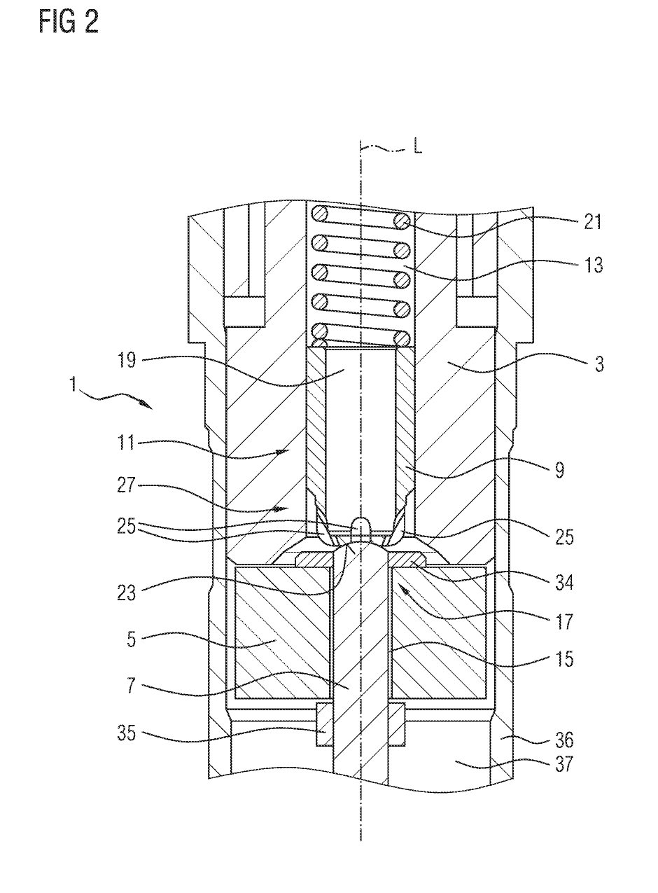

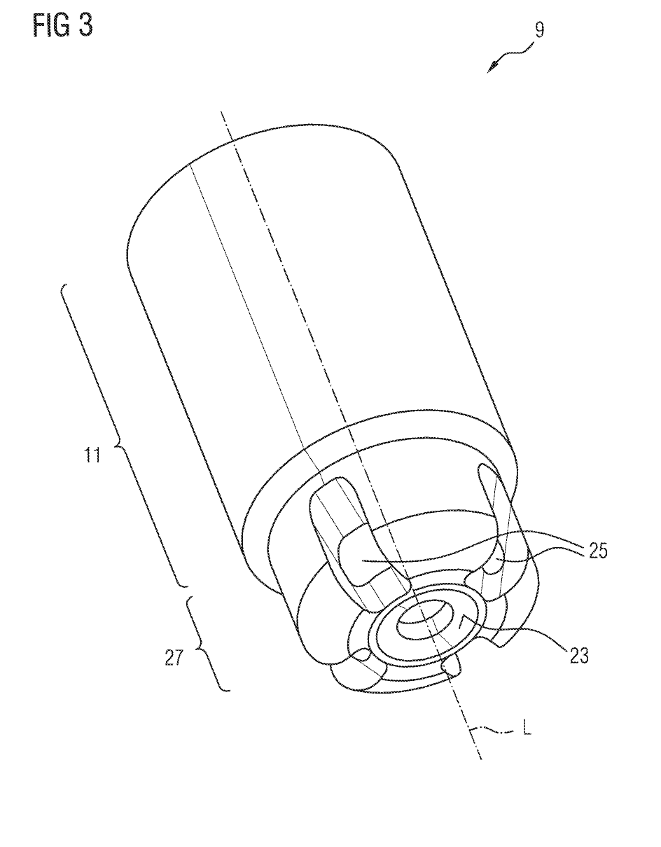

The injector 30 further includes an assembly 1 which itself includes the pole piece 3 with a penetrating opening 13, the armature 5 with a penetrating opening 15, the valve needle 7 and a guiding element 9 with a penetrating opening 19. A more detailed illustration of the assembly 1 will be described below with respect to FIGS. 2 and 3.

FIG. 2 shows a longitudinal section view of an embodiment of the assembly 1. This embodiment illustrates a detailed view of the embodiment described in FIG. 1. The guiding element 9 of the assembly 1 is shown in a perspective view in FIG. 3.

The guiding element 9 includes a cylindrically shaped guiding portion 11 and a lower portion 27 which is positioned between the guiding portion 11 and the valve needle 7 with respect to the longitudinal axis L.

The guiding element 9 is arranged in axially movable fashion inside the penetrating opening 13 of the pole piece 3 and has a contact surface 23 which is coupled to an upper end 17 of the valve needle 7 by a simple mechanical contact, in particular a form-fit connection. In further embodiments of the assembly 1 the guiding element 9 may be coupled to the valve needle 7 by further components of the assembly 1 and hence not directly contact the valve needle 7. The guiding element 9 with the guiding portion 11 is configured to realize a secure and reliable linear guidance of the valve needle 7 in the longitudinal direction. In particular, the cylindrical guiding portion 11 is in sliding contact with an inner circumferential surface of the pole piece 3 which defines the penetrating opening 13 of the pole piece 3 and prevents tilting of the upper end 17 of the valve needle 7 with respect to the longitudinal axis L by means of the interaction between the contact surface 23 with the upper end 17 of the valve needle 7 and by means of the interaction between the guiding portion 11 with the pole piece 3.

Such a configuration of the assembly 1 for a combustion engine realizes in a simple and cost-effective manner a reliable and secure functioning of the valve needle 7 and the corresponding injector 30 with an improved guidance of the valve needle 7 due to the described guiding element 9. The guiding element 9 enables an improved linear guidance of the valve needle 7 due to the cylindrically shaped guiding portion 11 which realizes a large contact area between the guiding element 9 and the pole piece 3.

Because of the large contact area between the guiding element 9 and the pole piece 3, the assembly 1 contributes to an enhanced linear guidance of the valve needle 7 compared to other injectors which do not include such a guiding element 9. This counteracts wearing of the assembly 1 and the injector 30 including an embodiment of the assembly 1 and hence increases its lifetime. During operation of the assembly 1 and motion of the valve needle 7, the guiding element 9 slightly contacts an inner surface of a wall of the pole piece 3 inside the penetrating opening 13 by an outer surface of the guiding portion 11 of the guiding element 9 which enables an improved linear guidance. The described guiding element 9 further increases a precision of the moveable valve needle 7 due to the centerless ground cylindrical shape of the guiding portion 11 inside the penetrating opening 13 of the pole piece 3.

The increased precision further allows for lower clearances between cooperating components and hence reducing a possible non-coaxiality. With respect to the longitudinal axis L of the assembly 1, this concerns a coaxiality of the armature 5 inside the valve body 36 of the injector 30, for example. If the concentricity of the armature 5 inside the valve body 36 is improved, side magnetic forces are reduced which further lowers wearing of the assembly 1 and the injector 30.

Due to the enhanced precision concerning linear guidance of the valve needle 7, the described assembly 1, and especially the guiding element 9, further enables abdication of special coatings of contacting surfaces. For example, using one embodiment of the assembly 1, there is no need for a chrome plating inside the penetrating opening 13 of the pole piece 3 and a PVD-coating at the upper end 17 of the valve needle 7. This further simplifies a manufacturing process of the assembly 1 and the injector 30 and also contributes to a cost-efficient fabrication.

Regarding its geometry and material, the guiding element 9 may be realized as a simple and low cost component of the assembly 1 and enables an easy manufacturing process. Hence, a complexity of the assembly 1 is reduced due to the possible simple design of the guiding element 9. The guiding element 9 includes a shape of a sleeve or a cap and may be manufactured just by a stamping process from a given raw material.

The guiding element 9 is pressed against the upper end 17 of the valve needle 7 due to a force generated by the elastic element 21 and is otherwise axially displaceable relative to the valve needle 7. The guiding element 9 is not welded or press-fitted to the valve needle 7. Thus, the guiding element 9 may be even made by non-iron based material such as plastic, for example. This increases a choice of material of the guiding element 9 and simplifies a manufacturing process of the guiding element 9. Moreover, it counteracts undesirable magnetism effects concerning this part of the assembly 1 and the injector 30.

The elastic element 21 may be realized as a coil spring and is arranged inside the penetrating opening 13 of the pole piece 3 bearing against an axial end of the guiding element 9 remote from the valve needle 7 with respect to the longitudinal axis L. The guiding element 9 is also arranged inside the penetrating opening 13 of the pole piece 3 such that it mechanically contacts the upper end 17 of the valve needle 7 by the contact surface 23 due to the elastic force generated by a given load of the elastic element 21. In this way, the spring force of the elastic element 21 is transferred to the valve needle 7 by the guiding element 9 to bias the valve needle 7 towards the closed position.

The contact surface 23 of the guiding element 9 may have a rotationally symmetric shape—preferably a spherical shape—that abuts the upper end 17 of the valve needle 7. This may be beneficial because a spherical or rotationally symmetric contact surface 23 enables a rotation freedom of the valve needle 7 during operation which is useful to compensate tolerance and shape errors of manufactured components of the assembly 1 or the corresponding injector 30. In particular, the contact surface 23 has a concave spherical shape and the upper end 17 of the valve needle 7 has a convex spherical shape which matches the shape of the contact surface 23. Advantageously, self-centering of the upper end 17 with respect to the longitudinal axis L may be achievable in this way.

The penetrating opening 19 of the guiding element 9 has a fluid inlet aperture at a first axial end of the guiding element 9 remote from the valve needle 7, i.e. at the upstream end of the guiding element 9. In its lower portion 27, the guiding element 9 includes four flow passages 25 in the present embodiment to enable a fluid to flow through during operation of the assembly 1. The flow passages 25 are formed by oblique cuts penetrating the circumferential sidewall of the lower portion 27 and the bottom wall of the guiding element 9 (see in particular FIG. 3). The bottom wall also includes the contact surface 23 which follows the flow passages 25 in radial inward direction. By means of the oblique cuts, openings are formed at an outer circumferential edge of the guiding element 9 at that axial end which abuts the valve needle 7. This enables one simple possibility to realize a fluid channel through the assembly 1 and the injector 30 wherein the one or more flow passages 25 form one part of the penetrating opening 19 of the guiding element 9. For this reason, there is no necessity for complex geometries with side channels or flats, for example. In addition, the guiding element 9 has a central opening in the bottom wall which is circumferentially surrounded by the contact surface 23. By means of the central opening, hydraulic sticking of the valve needle 7 and the contact surface 23 may be particularly small.

On its way through the valve body 36 from a fluid inlet of the injector 30 to a fluid outlet of the injector 30, fluid passes the penetrating opening 13 of the pole piece 3 and subsequently enters the penetrating opening 19 of the guiding element 9 through the fluid inlet aperture of the penetrating opening 19 of the guiding element 9. The fluid further exits the penetrating opening 19 of the guiding element 9 at the opposite axial end of the guiding element 9 through the flow passages 25 into the penetrating opening of the valve body 36 in a region of the armature 5. Furthermore, the fluid flows around the armature 5 and/or through the penetrating opening 15 of the armature 5 and/or through dedicated flow channels optionally provided in the armature and flows further through the penetrating opening 37 of the valve body 36 to reach the nozzle 38 and the nozzle tip 39 at the fluid outlet end of the injector 30.

Hence, during operation of the assembly 1 or the injector 30, the guiding element 9 will be passed through by fluid and enables in a simple manner a linear guidance of the valve needle 7 in an upper part of the injector 30 with a secure and reliable functioning. A further axial guide is provided by means of the nozzle tip 39 and the nozzle 38 being in sliding mechanical contact to prevent tilting of the downstream end of the valve needle 7 with respect to the longitudinal axis L.

1. An injector for a combustion engine, comprising:
a pole piece with a penetrating opening,
an armature with a penetrating opening,
a valve needle and
a guiding element with a guiding portion and a penetrating opening,
wherein
at least the respective penetrating openings of the pole piece and the guiding element are configured to form a portion of a fluid channel for a fluid along a longitudinal axis of the injector,
the valve needle is arranged at least partially inside the penetrating opening of the armature and is configured to be axially moveable along the longitudinal axis to prevent fluid flow in a closed position of the valve needle and to enable fluid flow in an opened position of the valve needle,
the guiding element is arranged with the guiding portion at least partially inside the penetrating opening of the pole piece with the guiding portion being in contact with the pole piece and having a cylindrical shape, and
the guiding element is axially moveable along the longitudinal axis relative to the pole piece and relative to the valve needle and is coupled to the valve needle to realize a guidance of the valve needle along the longitudinal axis during operation of the injector.

2. The injector in accordance with claim 1, wherein
the guiding element comprises a lower portion being arranged between the guiding portion and the valve needle, and
the lower portion comprises at least one flow passage being configured to enable a fluid flow through the injector during operation.

3. The injector in accordance with claim 2, wherein the at least one flow passage extends in radial direction through a sidewall of the guiding element to the penetrating opening of the guiding element.

4. The injector in accordance with claim 1, wherein the guiding element comprises a contact surface that abuts an end of the valve needle.

5. The injector in accordance with claim 4, wherein the contact surface of the guiding element comprises at least a partially spherical shape.

6. The injector in accordance with claim 1, wherein the guiding element contains a non-iron based material.

7. The injector in accordance with claim 1, wherein the guiding element contains at least one of a diamagnetic material and a paramagnetic material.

8. The injector in accordance with claim 1, wherein the valve needle is partially arranged inside the penetrating opening of the guiding element.

9. The injector in accordance with claim 1, further comprising an elastic element configured to exert a force on the guiding element to press the guiding element to the valve needle.

10. The injector in accordance with claim 9, wherein the elastic element is arranged inside the penetrating opening of the pole piece.
